(19) United States
(12) Patent Application Publication
(10) Pub. No.: US 2005/0271367 A1
(43) Pub. Date: Dec. 8, 2005

(54) Apparatus and method of encoding/decoding an audio signal

(76) Inventors: Joon-hyun Lee, Seongnam-si (KR); Seong-cheol Jang, Seoul (KR)

Correspondence Address: STANZIONE & KIM, LLP, 919 18TH STREET, N.W., SUITE 440, WASHINGTON, DC, 20006, US

(21) Appl. No.: 11/131,243

(22) Filed: May 18, 2005

Related U.S. Application Data
(60) Provisional application No. 60/576,617, filed on Jun. 4, 2004.
(60) Provisional application No. 60/578,862, filed on Jun. 14, 2004.

(30) Foreign Application Priority Data
Jun. 11, 2004 (KR) 2004-43075

(51) Int. Cl. H04N 5/76

(52) U.S. Cl. 386/96; 386/98

(57) ABSTRACT

An apparatus and method of encoding an audio signal and an apparatus and method of decoding an audio signal. The audio decoding method includes: generating an audio signal by decoding an input signal, and transforming an original waveform of the generated audio signal into a compensation waveform that is compensated for an acoustic resonance effect in the audio signal. Therefore, an audio signal having excellent sound quality without an amplified middle band can be heard via earphones, headphones, or a phone earpiece by using an inverse compensation waveform to compensate an ERP-DRP resonance effect, which is an acoustic resonance effect generated due to the structure of the human ear.

### CROSS-REFERENCE TO RELATED APPLICATIONS

This application claims priority from U.S. Provisional Patent Application No. 60/576,617, filed on Jun. 4, 2004, and No. 60/578,862, filed on Jun. 14, 2004, in the U.S. Patent and Trademark Office, and Korean Patent Application No. 2004-43075, filed on Jun. 11, 2004, in the Korean Intellectual Property Office, the disclosures of which are incorporated herein in their entirety by reference.

### BACKGROUND OF THE INVENTION

1. Field of the Invention

The present general inventive concept relates to an apparatus and a method of encoding an audio signal and an apparatus and a method of decoding an audio signal.

2. Description of the Related Art

FIG. 1 illustrates the structure of a human ear used to detect sound.

Referring to FIG. 1, when an ear reference point (ERP) on an external part of the human ear is sealed by earphones, headphones, a phone ear piece, etc. a sealed space is formed between the ERP and a drum reference point (DRP) on a middle part of the human ear. Therefore, when the human ear detects an audio signal output from the audio device, a resonance effect increases sound pressure by more than 15 dB in a frequency region (around a 1˜10 KHz band) that corresponds to a resonance frequency of the sealed space. Due to this ERP-DRP resonance effect, even if high quality earphones, headphones, or phone ear pieces are used, there is a problem in that people hear an audio signal having a middle band that is largely amplified. As a result, sound quality of the audio signal deteriorates. In particular, this problem is becoming more important as the use of earphones, headphones, phone ear pieces, etc. increases along with the widespread use of portable audio devices and cell-phones.

### SUMMARY OF THE INVENTION

The present general inventive concept provides an apparatus and a method of decoding an audio signal to compensate for an ERP-DRP resonance effect in an audio decoding operation.

The present general inventive concept also provides a computer readable medium having executable code to perform the audio decoding method.

The present general inventive concept also provides an apparatus and a method of encoding an audio signal at a higher compression rate in an audio encoding operation by considering an ERP-DRP resonance effect.

The present general inventive concept also provides a computer readable medium having executable code to perform the audio encoding method.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an audio decoding method, comprising generating an audio signal by decoding an input signal, and transforming an original waveform of the audio signal into a compensation waveform that is compensated for an acoustic resonance effect.

The foregoing and/or other aspects of the present general inventive concept are also achieved by providing an audio decoding apparatus, comprising a decoder to generate an audio signal by decoding an input signal, and a resonance compensator to transform an original waveform of the audio signal generated by the decoder into a compensation waveform that is compensated for an acoustic resonance effect.

The foregoing and/or other aspects of the present general inventive concept are also achieved by providing a computer readable medium having executable code to perform the audio decoding method.

The foregoing and/or other aspects of the present general inventive concept are also achieved by providing an audio encoding method, comprising calculating a signal-to-mask ratio (SMR) of each of a plurality of sub-band samples of an audio signal according to a masking threshold curve that is adjusted to account for an acoustic resonance effect, allocating bits to each of the sub-band samples according to the calculated signal-to-mask ratios, and quantizing and encoding the sub-band samples in a range of the allocated bits.

The foregoing and/or other aspects of the present general inventive concept are achieved by providing an audio encoding apparatus, comprising a psychoacoustic model unit to calculate a signal-to-mask ratio of each of a plurality of sub-band samples of an audio signal according to a masking threshold curve that is adjusted to account for an acoustic resonance effect, a bit allocator to allocate bits to each of the sub-band samples according to the calculated signal-to-mask ratios, and a quantizing/encoding unit to quantize and encode the sub-band samples in a range of the allocated bits.

The foregoing and/or other aspects of the present general inventive concept are also achieved by providing a computer readable medium having executable code to perform the audio encoding method.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates the structure of human ear used to detect sound;

FIG. 2 is a graph illustrating a resonance waveform between an ear reference point (ERP) and a drum reference point (DRP) of the human ear;

FIG. 3 is a graph illustrating a compensation waveform obtained by inverting the resonance waveform of FIG. 2;

FIG. 4 is a graph illustrating a result obtained by applying the compensation waveform of FIG. 3 to the resonance waveform of FIG. 2;

FIG. 5 is a block diagram illustrating an audio decoding apparatus according to an embodiment of the present general inventive concept;

FIG. 6 is a flowchart illustrating a method of decoding an audio signal according to an embodiment of the present general inventive concept;

FIG. 7 illustrates a comparison of an audio signal reproduced by the audio decoding apparatus of FIG. 5 and an audio signal reproduced by a conventional audio decoding apparatus;

FIG. 8 illustrates a masking effect used to consider a resonance effect between the ERP and the DRP;

FIG. 9 is a block diagram illustrating an audio encoding apparatus according to an embodiment of the present general inventive concept; and

FIG. 10 is a flowchart illustrating an audio encoding method according to an embodiment of the present general inventive concept.

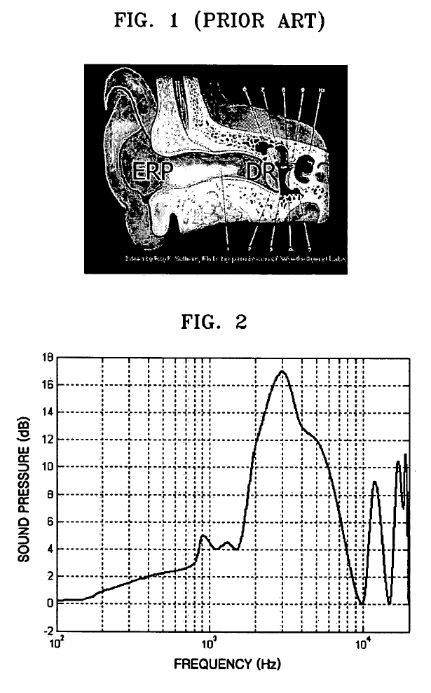

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 2 is a graph illustrating a resonance waveform between an ear reference point (ERP) and a drum reference point (DRP) of a human ear.

Referring to FIG. 2, a resonance waveform having a sound pressure that is increased by more than 15 dB at around a 1˜10 KHz band due to a sealed space between the ERP and the DRP is measured. The ERP-DRP resonance waveform can be measured by inserting a probe microphone into an ear of a person or a dummy head.

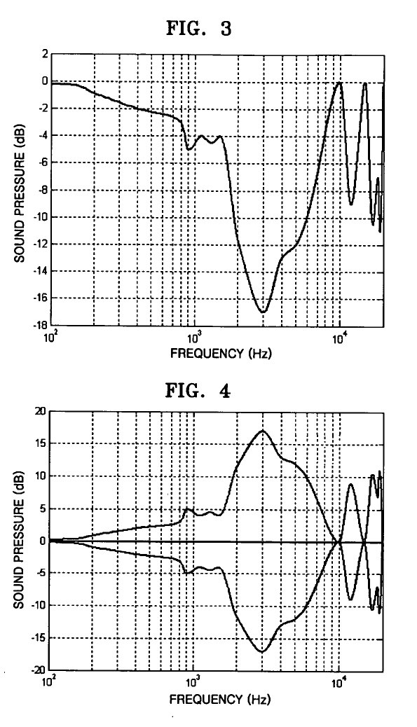

FIG. 3 is a graph illustrating a compensation waveform obtained by inverting the resonance waveform of FIG. 2.

Referring to FIG. 3, the compensation waveform is obtained by inverting the resonance waveform illustrated in FIG. 2 with respect to a frequency axis.

FIG. 4 is a graph illustrating a result obtained by applying the compensation waveform of FIG. 3 to the resonance waveform of FIG. 2.

Referring to FIG. 4, when an earphone or headphone user hears an audio signal to which the compensation waveform of FIG. 3 has been applied, the user actually hears an audio signal having an original waveform. Throughout the detailed description, the original waveform of the audio signal is assumed to be a flat waveform for illustration purposes. However, it should be understood that the original waveform of the audio signal can have a variety of other shapes.

Referring to FIGS. 2, 3, and 4, an audio decoding apparatus to compensate for the ERP-DRP resonance effect can be implemented by measuring a resonance waveform generated by the ERP-DRP resonance effect, calculating a compensation waveform by inverting the measured resonance waveform, designing one or more digital filters, such as a finite impulse response (FIR) filter and/or an infinite impulse response (IIR) filter, to apply the calculated compensation waveform to the measured resonance waveform, and implementing the designed digital filters in the audio decoding apparatus.

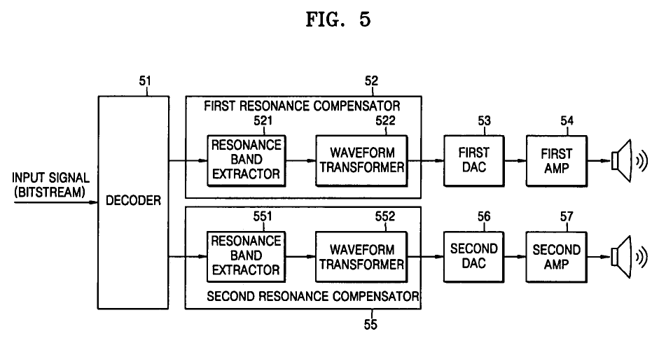

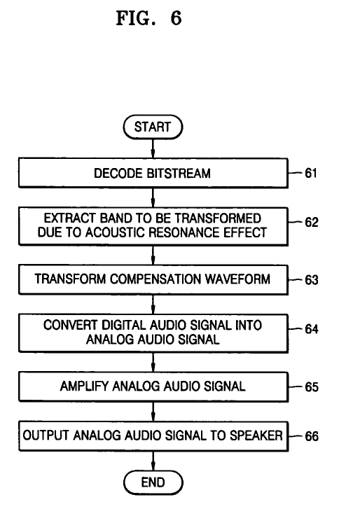

FIG. 5 is a block diagram illustrating an audio decoding apparatus according to an embodiment of the present general inventive concept.

Referring to FIG. 5, the audio decoding apparatus includes a decoder 51, a first resonance compensator 52, a first digital-to-analog converter (DAC) 53, a first amplifier 54, a second resonance compensator 55, a second DAC 56, and a second amplifier 57.

The decoder 51 generates an audio signal by decoding an input signal. Typically, the input signal may be a bitstream transmitted from an MPEG audio encoding apparatus.

The first resonance compensator 52 transforms a waveform of the audio signal generated by the decoder 51 into a first waveform that is compensated for the ERP-DRP resonance effect. As illustrated in FIG. 3, the compensation waveform used to compensate for the ERP-DRP resonance effect can be obtained by inverting the ERP-DRP resonance waveform illustrated in FIG. 2.

The first resonance compensator 52 includes a first resonance band extractor 521 and a first waveform transformer 522. The first resonance band extractor 521 extracts a band that is affected by the ERP-DRP resonance effect to be compensated for the ERP-DRP resonance effect. That is, the first resonance band extractor 521 may extract a band of around 1˜10 KHz from the audio signal. The first waveform transformer 522 transforms the band extracted by the first resonance band extractor 521 into a compensation waveform, which (when the audio signal is flat) can have the same shape as the compensation waveform illustrated in FIG. 3. As described above, the first resonance compensator 52 can be realized with one or more digital filters such as an FIR filter and an IIR filter.

The first DAC 53 converts the digital audio signal that has been transformed into the compensation waveform by the first resonance compensator 52 into an analog audio signal. As described above, the audio signal input to the first DAC 53 is a digital audio signal obtained by decoding the bitstream transmitted from the MPEG audio encoding apparatus and can be converted into the analog audio signal in order to be reproduced.

The first amplifier 54 outputs the analog audio signal converted by the first DAC 53 to a speaker. The speaker may be a left speaker of an audio device that forms a sealed space between the ERP and the DRP of the human ear, such as earphones, headphones, a phone ear piece, etc.

The second resonance compensator 55, the second DAC 56, and the second amplifier 57 perform the same functions as the first resonance compensator 52, the first DAC 53, and the first amplifier 54, respectively. Therefore, descriptions of the second resonance compensator 55, the second DAC 56, and the second amplifier 57 will not be provided. However, while the first resonance compensator 52, the first DAC 53, and the first amplifier 54 can process an audio signal output to the left speaker, the second resonance compensator 55, the second DAC 56, and the second amplifier 57 can process an audio signal output to a right speaker. Therefore, the decoder 51 provides decoded data to be output to the left speaker to the first resonance compensator 52 and decoded data to be output to the right speaker to the second resonance compensator 55. Although FIG. 5, illustrates that two channels (e.g., a left channel and a right channel) are processed and output by two corresponding output devices (e.g., speakers), it should be understood that the embodiments of the present general inventive concept may be used to process an audio signal for a single sound output device. For example, the embodiments of the present general inventive concept may be used to process sound for a phone ear piece.

FIG. 6 is a flowchart illustrating a method of decoding an audio signal according to an embodiment of the present general inventive concept.

Referring to FIG. 6, the audio decoding method includes operations 61 through 66. The audio decoding method illustrated in FIG. 6 includes a series of operations that may be executed by the audio decoding apparatus illustrated in FIG. 5. Alternatively, the method of FIG. 6 may be implemented by other audio devices.

In operation 61, an audio signal is generated by decoding an input signal.

In operation 62, a band that is affected by the ERP-DRP resonance effect (i.e., subsequently transformed due to the ERP-DRP resonance effect) is extracted from the audio signal.

In operation 63, the extracted band is transformed into a compensation waveform, which (when the audio signal is flat) may have the same shape as the compensation waveform illustrated in FIG. 3. Alternatively, when the audio signal is not flat, the compensation waveform can have different shapes.

That is, in operations 62 and 63, a waveform of the audio signal generated in operation 61 is transformed into the compensation waveform that is subsequently transformed due to the ERP-DRP resonance effect in the audio signal. Here, the compensation waveform that is subsequently transformed due to the ERP-DRP resonance effect is a compensation waveform obtained by inverting the ERP-DRP resonance waveform. Thus, the audio signal is compensated for the ERP-DRP resonance effect prior to when the ERP-DRP resonance effect actually occurs in the audio signal.

In operation 64, the digital audio signal having the compensation waveform obtained in operation 63 is converted into an analog audio signal. As described above, the digital audio signal having the compensation waveform obtained in operation 63 may be a digital audio signal obtained by decoding a bitstream transmitted from an MPEG audio encoding apparatus and can be converted into the analog audio signal in order to be reproduced. Alternatively, the digital audio signal can be obtained from a computer readable medium such as a sound file, a compact disc (CD), or a digital video disc (DVD).

In operations 65 and 66, the analog audio signal obtained in operation 64 and which has been compensated for the ERP-DRP resonance effect is amplified and output to a speaker. The ERP-DRP resonance effect then occurs when the analog audio signal is output by the speaker. Accordingly, an original audio signal having an original waveform is reproduced and can be detected by the human ear, since the ERP-DRP resonance effect transforms the compensation waveform into the original waveform of the original audio signal.

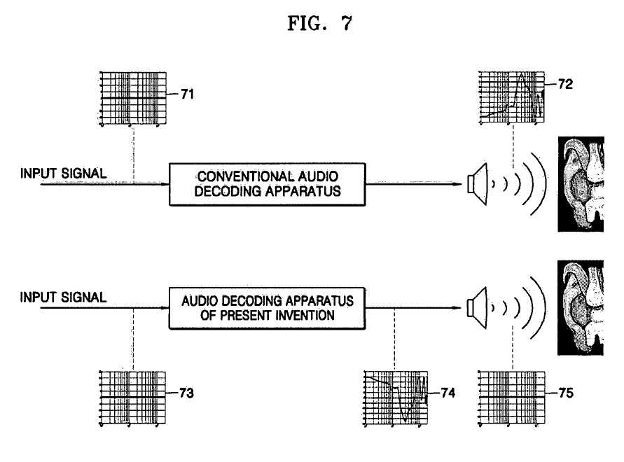

FIG. 7 illustrates a comparison of an audio signal reproduced by the audio decoding apparatus of FIG. 5 and an audio signal reproduced by a conventional audio decoding apparatus. A user may detect the reproduced audio signal using, for example, an earphone, a headphone, or a phone earpiece. Other audio devices that can create a sealed space between the ERP and the DRP of the human ear may also be used.

Referring to FIG. 7, when the user hears an output audio signal that corresponds to an input audio signal 71 having a flat waveform using a conventional audio decoding apparatus, the output audio signal actually detected by the user is a signal 72 having a waveform with a middle band that is amplified by about 15 dB.

However, when the user hears an output audio signal that corresponds to an input audio signal 73 having a flat waveform using the audio decoding apparatus according to an embodiment of the present general inventive concept, an audio signal output from the audio decoding apparatus according to the embodiment of the present general inventive concept is a signal 74 having a compensation waveform. Therefore, the output audio signal actually detected by the user is a signal 75 having the same flat waveform as the input audio signal 73. Thus, the original waveform of the input audio signal 73 can be obtained by pre-compensating the original waveform of the audio signal for the ERP-DRP resonance effect using the compensation waveform.

Therefore, when embodiments of the present general inventive concept are applied to portable audio devices, cell-phones, and personal digital assistants (PDAs), which use earphones, headphones, phone ear pieces, etc. an output audio signal having an excellent sound quality without an amplified middle band can be heard.

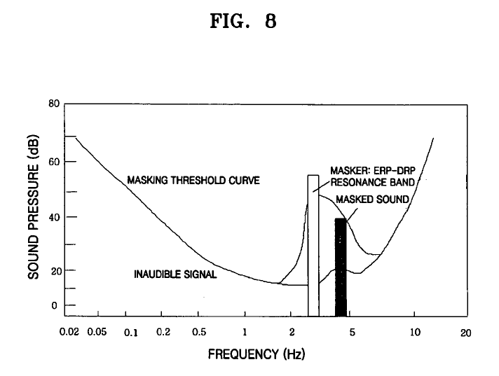

FIG. 8 illustrates a masking effect that occurs when considering the ERP-DRP resonance effect.

Most lossy audio compression algorithms emphasize a maximization of a level where human subjective sense cannot distinguish an original audio signal from a compressed audio signal when the original audio signal and the compressed audio signal are compared rather than a minimization of a mathematical error between the original audio signal and the compressed audio signal. In terms of a detailed compression process, sound that cannot be heard by human ears is removed, and bits are only allocated to represent sound that a person can hear. For example, since human ears can rarely hear very high and very low frequency components, the very high and very low frequency components can be excluded from the compression process. Additionally, a frequency component that is masked by a specific masking frequency based on the characteristics of human hearing can be encoded with lower accuracy than normal. The psychoacoustic model uses this masking effect according to interaction between the human ear and the brain. According to the psychoacoustic model, a maximum sound pressure of the frequency component that human ears cannot hear due to masking is called a masking threshold. Once the sound pressure of the frequency component exceeds the masking threshold, the frequency component can be heard over the specific masking frequency. Since audio signals having sound pressure less than the masking threshold cannot be heard, these audio signals can be removed by an audio encoding process.

Referring to FIG. 8, a middle band (i.e., an ERP-DRP resonance band) of a masking threshold curve is amplified by more than 15 dB due to the ERP-DRP resonance effect. If the ERP-DRP resonance band is considered to be a masker band, even if neighboring bands of the masker band can be heard in a normal state (i.e., without the ERP-resonance effect), the neighboring bands of the masker band cannot be heard since they are masked by the masker band. Therefore, a compression rate can be maximized by adjusting the masking threshold curve to account for the ERP-DRP resonance effect on the psychoacoustic model used to compress sound data.

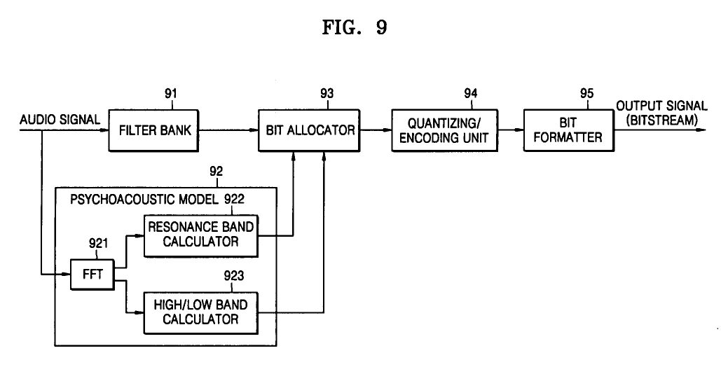

FIG. 9 is a block diagram illustrating an audio encoding apparatus according to an embodiment of the present general inventive concept.

Referring to FIG. 9, the audio encoding apparatus includes a filter bank 91, a psychoacoustic model unit 92, a bit allocator 93, a quantizing/encoding unit 94, and a bitstream formatter 95.

The filter bank 91 divides an audio signal into a plurality of sub-band samples. The audio signal input to the filter bank 91 and the psychoacoustic model unit 92 is a pulse code modulation (PCM) audio signal.

The psychoacoustic model unit 92 calculates a signal-to-mask ratio (SMR) of each of the sub-band samples of the audio signal according to a masking threshold curve that is adjusted to account for the ERP-DRP resonance effect. That is, the psychoacoustic model unit 92 calculates a signal-to-mask ratio of each of the sub-band samples of the audio signal considering an ERP-DRP resonance band having masking thresholds that have been increased due to the ERP-DRP resonance effect. Since the masking thresholds are adjusted due to the ERP-DRP resonance effect, both spectrum masking theory and temporal masking theory can be applied. Here, the applied masking theories can include simultaneous masking, pre-masking, and post-masking, which can be applied to conventional perceptual coding.

The psychoacoustic model unit 92 includes an FFT (fast Fourier transform) unit 921, a resonance band calculator 922, and a high/low band calculator 923.

The FFT unit 921 calculates a spectrum waveform by performing a fast Fourier transform of the audio signal.

The resonance band calculator 922 calculates a band that is subsequently transformed due to the ERP-DRP resonance effect. The resonance band calculator 922 also calculates an SMR of the ERP-DRP resonance band. In particular, the resonance band calculator 922 calculates the SMR of the ERP-DRP resonance band by determining masking thresholds of the ERP-DRP resonance band and sound pressure levels of the sub-band samples from the spectrum waveform calculated by the FFT unit 921. The resonance band calculator 922 then calculates differences between the determined masking thresholds of the ERP-DRP resonance band and sound pressure levels of the sub-band samples. Accordingly, the resonance band calculator 922 can determine a masking effect that the ERP-DRP resonance band provides on sub-band samples that surround the ERP-DRP resonance band.

The high/low band calculator 923 calculates SMRs of high/low bands corresponding to bands other than the ERP-DRP resonance band (i.e., bands that surround the ERP-DRP resonance band). In particular, the high/low band calculator 923 calculates the SMRs of the high/low bands by determining masking thresholds of the high/low bands and the sound pressure levels of the sub-band samples from the spectrum waveform calculated by the FFT unit 921. The high/low band calculator 923 then calculates differences between the determined masking thresholds and the sound pressure levels of the sub-band samples. Accordingly, the high/low band calculator 923 can determine a masking effect that masking bands, other than the ERP-DRP resonance band, provide on the sub-band samples.

When the psychoacoustic model unit 92 is implemented according to the ERP-DRP resonance band, the resonance band calculator 922 and the high/low band calculator 923 can be implemented as a single combined unit or as two separate units.

The bit allocator 93 then allocates bits to each of the sub-band samples divided by the filter bank 91 according to the SMRs calculated by the psychoacoustic model unit 92.

For example, with regard to the masking effect of the ERP-DRP resonance band, when a sub-band sample has a sound-pressure that is less than or equal to the corresponding masking threshold of the ERP-DRP resonance band (i.e., a SNR that is less than or equal to 1), no bits need to be allocated to that sub-band sample, since the sub-band sample is inaudible due to the ERP-DRP resonance effect. Likewise, when a sub-band sample having a sound pressure that exceeds the corresponding masking threshold of the ERP-DRP resonance band (i.e., a SNR of greater than 1), bits are allocated to the sub-band sample, since the sub-band sample is audible regardless of the ERP-DRP resonance effect. In a similar manner, bits are either allocated or not allocated to sub-band samples according to the determination of the masking effect of other high/low masking bands made by the high/low band calculator 923.

The quantizing/encoding unit 94 quantizes and encodes the sub-band samples in a range of the allocated bits.

The bitstream formatter 95 formats the quantized and encoded sub-band samples to a bitstream by adding bit allocation information and additional information to the quantized and encoded sub-band samples. In general, the bitstream formatter 95 formats the quantized and encoded sub-band samples according to an MPEG standard.

The bitstream output from the bitstream formatter 95 is transmitted to the audio decoding apparatus.

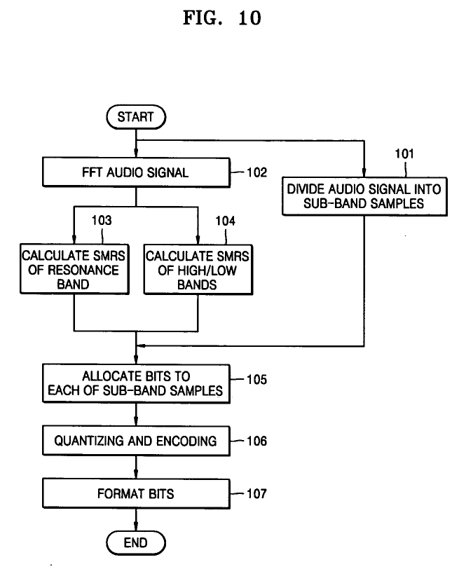

FIG. 10 is a flowchart illustrating a method of encoding an audio signal according to an embodiment of the present general inventive concept.

Referring to FIG. 10, the audio encoding method includes operations 101 through 107. The audio encoding method illustrated in FIG. 10 includes a series of operations that can be executed by the audio encoding apparatus illustrated in FIG. 9. Alternatively, the method of FIG. 10 can be performed by other audio devices.

In operation 101, an audio signal is divided into a plurality of sub-bands.

In operation 102, a spectrum waveform is calculated by performing a fast Fourier transform on the audio signal.

In operation 103, an SMR of an ERP-DRP resonance band is calculated. In particular, the SMR of the ERP-DRP resonance band is calculated by determining masking thresholds of the ERP-DRP resonance band and sound pressure levels of the sub-band samples from the spectrum waveform calculated in operation 102, and calculating differences between the determined masking thresholds of the ERP-DRP resonance band and sound pressure levels of the sub-band samples.

In operation 104, SMRs of high/low bands corresponding to bands other than the ERP-DRP resonance band (i.e., bands that surround the ERP-DRP resonance band) are calculated. In particular, the SMRs of the high/low bands are calculated by determining masking thresholds of the high/low bands and sound pressure levels of the sub-band samples from the spectrum waveform calculated in operation 102, and calculating differences between the determined masking thresholds of the high/low bands and sound pressure levels of the sub-band samples.

That is, in operations 103 and 104, the SMRs of the sub-band samples of the audio signal are calculated according to the masking thresholds that are transformed due to the ERP-DRP resonance effect.

In operation 105, bits are allocated to each of the sub-band samples divided in operation 101 according to the SMRs calculated in operations 103 and 104.

In operation 106, the sub-band samples are quantized and encoded in a range of the bits allocated in operation 105.

In operation 107, the sub-band samples quantized and encoded in operation 106 are formatted into a bitstream by adding bit allocation information and additional information to the quantized and encoded sub-band samples.

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet).

As described above, according to the embodiments of the present general inventive concept, an audio signal having excellent sound quality without an amplified middle band can be heard by a user with earphones, headphones, a phone earpiece, etc. by using a compensation waveform to compensate for an ERP-DRP resonance effect, which is an acoustic resonance effect that results from the structure of the human ear. In particular, the ERP-DRP resonance effect, which has become an important problem with the widespread use of portable audio devices, such as portable DVD players and MP3 players, and cell-phones, can be compensated.

Additionally, a compression rate can be largely improved by adding a function to encode bands that are masked by an ERP-DRP resonance band at a higher compression rate than the other bands by considering masking thresholds that are transformed due to the ERP-DRP resonance effect according to a psychoacoustic model used to encode high/low bands that cannot be heard by people at a higher compression rate than the other bands.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An audio decoding method, comprising:
generating an audio signal by decoding an input signal; and
transforming an original waveform of the audio signal into a compensation waveform that is compensated for an acoustic resonance effect.

2. The audio decoding method of claim 1, wherein the transforming of the original waveform of the audio signal comprises pre-compensating the original waveform of the audio signal prior to an occurrence of the acoustic resonance effect.

3. The audio decoding method of claim 1, further comprising:
outputting the compensation waveform such that the compensation waveform is converted to the original waveform by the acoustic resonance effect.

4. The audio decoding method of claim 1, wherein the acoustic resonance effect comprises an ERP-DRP resonance effect generated between an ear reference point (ERP) and a drum reference point (DRP).

5. The audio decoding method of claim 1, wherein the transforming of the original waveform of the audio signal comprises obtaining the compensation waveform by inverting a resonance waveform obtained due to the acoustic resonance effect.

6. The audio decoding method of claim 5, wherein the resonance waveform is obtained experimentally using a dummy head.

7. The audio decoding method of claim 1, wherein the transforming of the original waveform comprises:
extracting a band from the audio signal that is subsequently transformed due to the acoustic resonance effect; and
transforming the extracted band into the compensation waveform.

8. The audio decoding method of claim 1, wherein the audio signal is a digital audio signal, and the method further comprises:
converting the digital audio signal having the compensation waveform into an analog audio signal.

9. A method of compensating for an acoustic resonance effect in an audio signal, the method comprising:
determining a resonance waveform caused by the acoustic resonance effect;
calculating a compensation waveform by determining an inverse of the resonance waveform;
applying the compensation waveform to the audio signal; and
outputting the audio signal having the compensation waveform applied thereto.

10. The method of claim 9, wherein the applying of the compensation waveform to the audio signal comprises:
extracting a frequency band that is affected by the acoustic resonance effect; and
transforming the extracted frequency band to the compensation waveform.

11. The method of claim 9, wherein:
the applying of the compensation waveform comprises transforming an original waveform of the audio signal into the compensation waveform; and
the outputting of the audio signal comprises creating the acoustic resonance effect to transform the compensation waveform back into the original waveform.

12. The method of claim 9, further comprising:
receiving the audio signal from a decoder, the audio signal including a left channel signal and a right channel signal.

13. The method of claim 12, wherein:
the determining of the resonance waveform comprises determining a first resonance waveform caused by the acoustic resonance effect in a left user ear and determining a second resonance waveform caused by the acoustic resonance effect in a right user ear;
the calculating of the compensation waveform comprises calculating a first compensation waveform by determining an inverse of the first resonance waveform and calculating a second compensation waveform by determining an inverse of the second resonance waveform; and
the applying of the compensation waveform to the audio signals comprises applying the first and second compensation waveforms to the left and right channel signals, respectively.

14. An audio decoding apparatus, comprising:
a decoder to generate an audio signal by decoding an input signal; and
a resonance compensator to transform an original waveform of the audio signal generated by the decoder into a compensation waveform that is compensated for an acoustic resonance effect.

15. The audio decoding apparatus of claim 14, wherein the resonance compensator pre-compensates the original waveform of the audio signal prior to an occurrence of the acoustic resonance effect.

16. The audio decoding apparatus of claim 14, further comprising:
a speaker to output the compensation waveform such that the compensation waveform is converted to the original waveform by the acoustic resonance effect.

17. The audio decoding apparatus of claim 16, wherein the speaker forms a sealed space with a user ear and outputs the compensation waveform such that the compensation waveform resonates in the sealed space.

18. The audio decoding apparatus of claim 16, wherein the speaker comprises one of headphones, earphones, and a phone ear piece.

19. The audio decoding apparatus of claim 14, wherein the acoustic resonance effect comprises an ERP-DRP resonance effect generated between an ear reference point (ERP) and a drum reference point (DRP).

20. The audio decoding apparatus of claim 14, wherein the compensation waveform is obtained by inverting a resonance waveform obtained due to the acoustic resonance effect.

21. The audio decoding apparatus of claim 14, wherein the resonance compensator comprises:
a resonance band extractor to extract a band from the audio signal that is subsequently transformed due to the acoustic resonance effect; and
a waveform transformer to transform the extracted band into the compensation waveform.

22. An apparatus to compensate for an acoustic resonance effect in an audio signal, comprising:
a decoder to receive an audio signal and decode the received audio signal;
at least one waveform transformer to apply a compensation waveform to the audio signal; and
at least one speaker unit to output the audio signal having the compensation waveform applied thereto, wherein the compensation waveform comprises an inverse of a resonance waveform caused by the acoustic resonance effect.

23. A computer readable medium having executable code thereon to perform an audio decoding method, the medium comprising:
a first executable code to generate an audio signal by decoding an input signal; and
a second executable code to transform an original waveform of the audio signal into a compensation waveform that is compensated for an acoustic resonance effect.

24. An audio encoding method, comprising:
calculating a signal-to-mask ratio (SMR) of each of a plurality of sub-band samples of an audio signal according to a masking threshold curve that is adjusted to account for an acoustic resonance effect;
allocating bits to each of the sub-band samples according to the calculated signal-to-mask ratios; and
quantizing and encoding the sub-band samples in a range of the allocated bits.

25. The audio encoding method of claim 24, wherein the acoustic resonance effect comprises an ERP-DRP resonance effect generated between an ear reference point (ERP) and a drum reference point (DRP).

26. The audio encoding method of claim 24, wherein the calculating of the SMR of each of the plurality of sub-band samples of the audio signal comprises:
calculating the signal-to-mask ratio of each of the sub-band samples of the audio signal according to an ERP-DRP resonance band having masking thresholds that are increased due to an ERP-DRP resonance effect.

27. The audio encoding method of claim 24, wherein the calculating of the SMR of each of the plurality of sub-band samples of the audio signal comprises:
calculating the SMRs by:
determining masking thresholds that are subsequently transformed due to the acoustic resonance effect,
determining corresponding sound pressure levels of the sub-band samples from a waveform of the audio signal, and
calculating differences between the determined masking thresholds and the determined corresponding sound pressure levels.

28. The audio encoding method of claim 24, wherein the calculating of the SMR of each of the plurality of sub-band samples of the audio signal comprises:
calculating SMRs of a resonance band corresponding to a band that is subsequently transformed due to the acoustic resonance effect; and
calculating SMRs of high and low bands corresponding to bands other than the resonance band.

29. A method of increasing a compression rate in an audio encoding apparatus, the method comprising:
determining an acoustic resonance band that is amplified by an acoustic resonance effect when reproducing an audio signal having a plurality of sub-bands;
determining whether any of the plurality of sub-bands in the audio signal are masked by the acoustic resonance band; and
encoding the audio signal with a first amount of bits allocated for signal information of sub-bands that are not masked by the acoustic resonance band and a second amount of bits allocated for signal information of sub-bands that are masked by the acoustic resonance band.

30. The method of claim 29, wherein the first amount of bits is greater than the second amount of bits.

31. The method of claim 30, wherein the determining of the acoustic resonance band comprises adjusting a predetermined masking threshold curve around the acoustic resonance band to compensate for the acoustic resonance effect.

32. The method of claim 31, wherein the determining of whether any of the plurality of sub-bands in the audio signal are masked comprises comparing signal levels of each of the plurality of sub-bands with corresponding masking thresholds from the adjusted masking threshold curve to determine whether the signal information of each of the plurality of sub-bands is audible with the acoustic resonance effect.

33. The method of claim 29, wherein the acoustic resonance band is around 1 to 10 KHz, and the acoustic resonance effect is caused when a sealed space is formed in at least one user ear by at least one speaker.

34. An audio encoding apparatus, comprising:
a psychoacoustic model unit to calculate a signal-to-mask ratio of each of a plurality of sub-band samples of an audio signal according to a masking threshold curve that is adjusted to account for an acoustic resonance effect;
a bit allocator to allocate bits to each of the sub-band samples according to the calculated signal-to-mask ratios; and
a quantizing/encoding unit to quantize and encode the sub-band samples in a range of the allocated bits.

35. The audio encoding apparatus of claim 34, wherein the acoustic resonance effect comprises an ERP-DRP resonance effect generated between an ear reference point (ERP) and a drum reference point (DRP).

36. The audio encoding apparatus of claim 34, wherein the psychoacoustic model unit calculates a signal-to-mask ratio of each of the sub-band samples of the audio signal according to an ERP-DRP resonance band having masking thresholds that are increased due to an ERP-DRP resonance effect.

37. The audio encoding apparatus of claim 36, wherein the psychoacoustic model unit comprises:
a resonance band calculator to calculate SMRs of a resonance band corresponding to a band that is subsequently transformed due to the acoustic resonance effect; and
a high/low band calculator to calculate SMRs of high and low bands corresponding to bands other than the resonance band.

38. An encoding apparatus to increase a compression rate of audio signal information, comprising:
a resonance band calculator to determine an acoustic resonance band that is amplified by an acoustic resonance effect when reproducing an audio signal having a plurality of sub-bands and to determine whether any of the plurality of sub-bands in the audio signal are masked by the acoustic resonance band; and
a bit allocation unit to allocate bits for signal information of sub-bands that are not masked by the acoustic resonance band and to allocate no bits for signal information of sub-bands that are masked by the acoustic resonance band.

39. The encoding apparatus of claim 38, wherein the resonance band calculator adjusts a predetermined masking threshold curve to compensate for the acoustic resonance effect.

40. The encoding apparatus of claim 39, wherein the resonance band calculator compares signal levels of each of the plurality of sub-bands with corresponding masking thresholds from the adjusted masking threshold curve to determine whether the signal information of each of the plurality of sub-bands is audible with the acoustic resonance effect.

41. The encoding apparatus of claim 38, further comprising:
a quantizing/encoding unit to encode the signal information of the plurality of sub-bands according to the bits allocated by the bit allocation unit.

42. The encoding apparatus of claim 38, wherein the resonance band is around 1 to 10 KHz, and the acoustic resonance effect is caused when a sealed space is formed in at least one user ear by at least one speaker.

43. The encoding apparatus of claim 38, further comprising:
a high/low band calculator to determine whether any of the plurality of sub-bands in the audio signal are masked by other frequency bands of the audio signal and to provide the determination to the bit allocation unit.

44. A computer readable medium having executable code thereon to perform an audio encoding method, the medium comprising:
a first executable code to calculate an SMR of each of a plurality of sub-band samples of an audio signal according to a masking threshold curve that that is adjusted to account for an acoustic resonance effect;
a second executable code to allocate bits to each of the sub-band samples according to the calculated signal-to-mask ratios; and
a third executable code to quantize and encode the sub-band samples in a range of the allocated bits.
